(19) United States
(12) Patent Application Publication
(10) Pub. No.: US 2012/0205563 A1
(43) Pub. Date: Aug. 16, 2012

(54) VALVE ARRANGEMENT FOR ACTUATING A LOAD

(76) Inventor: Winfried Rueb, Waldshut-Tiengen (DE)

(21) Appl. No.: 13/261,265

(22) PCT Filed: Nov. 9, 2010
(86) PCT No.: PCT/EP2010/006814

§ 371 Date: Apr. 17, 2012

(30) Foreign Application Priority Data
Dec. 15, 2009 (DE) 10 2009 058 371.8

(51) Int. Cl. F16K 31/12

(52) U.S. Cl. 251/12

(57) ABSTRACT

The invention relates to a valve arrangement for actuating a load (2), having an infinitely variable directional control valve (3) acting as inlet throttle via which a pump connection (P) can be connected to load connections (A, B). The load (2) is connected via working lines (4, 5) to the directional control valve (3) and a discharge volumetric flow (6) of a pressure medium (7) from the load (2) can be adjusted via a throttle device (8) on the basis of a load signal (LS) of the load (2). The throttle device (8) can be adjusted by a dynamic pressure (p′) derived from the load signal (LS). The valve arrangement is characterised in that the throttle device (8) is actuated via a hydraulic circuit (17), which detects the magnitude and direction of a pressure medium flow (7) to the load (2).

The invention relates to a hydraulic valve arrangement for actuating a load, having an infinitely variable directional control valve, which acts as the inlet throttle and can connect a pump port to the load ports, wherein the load is connected to the directional control valve by means of working lines; and a discharge volumetric flow of a pressure medium from the load can be adjusted by means of a throttle device as a function of a load signal of the load, and the throttle device can be adjusted by a dynamic pressure derived from the load signal.

Valve arrangements are used in the mobile hydraulic system of working machines, for example, to actuate single-acting and double-acting loads or for actuating rotating mechanisms, such as hydraulic motors and power lifts. Hence, a throttle device, which can throttle the incoming and outgoing volumetric flow of the hydraulic oil, is integrated into the working lines running to the respective load.

In order to throttle the inflow and discharge of the pressure medium, each working line has a valve throttle with mechanically coupled valve members. The relation between the inflow opening and the discharge opening of the valve throttles is determined by the mechanical coupling of the opening edges of the joint valve spool so that a specific pressure drop in the discharge line corresponds to a specific setting of the respective valve throttle. This drop in pressure is undesired especially when connecting single-acting loads, because it does not represent a meaningful function. The pressure drop leads to energy losses, an increase in the temperature of the pressure medium, and in some cases to premature wear and tear of the valve throttle.

Furthermore, it is known to provide hydraulic loads having pulling load direction with a lowering brake valve in the assigned working line or to insert the lowering brake valve into at least the working line that supplies the piston chamber with the pressure medium. If such lowering brake valves are attached directly to a working cylinder, then this feature makes it possible to provide in a safe and effective way the respective working line with rupture protection. In the event of a leak in the working line, a non-return seat valve can seal off the working line. Then the working cylinder comes to a stop. Such lowering brake valves are opened by a pressure of the pressure medium in the corresponding working line and are closed again by an actuator, such as a compression spring.

Lowering brake valves suppress not only an uncontrolled drop, but also a fluid fill deficit on the inlet side and, thus, cavitation. In one working phase or lifting phase of a working cylinder, the lowering brake valve is bypassed by a check valve. However, the flow through the check valve causes high pressure losses. In addition, instability may arise when the system is running. In order to eliminate such phenomena, the pressure medium is often prestressed with a very high pressure, for example, 70 bar. For example, in the case of a hydraulic cylinder that is used to lift loads, the result is that even in the course of a lowering operation the load has to be compressed, even though the load would decrease by itself without prestressing the pressure medium.

One possibility for stabilizing such systems is the use of pipe rupture protection valves that are designed with a proportional control valve behavior and are actuated, for example, with an actuating pressure of a directional control valve. The opening signal of such pipe rupture protection valves is not coupled to the respective load or a load pressure, so that there is no chance whatsoever of instabilities. However, there is the drawback that an additional actuating line to an optionally remote working cylinder is necessary. Therefore, the costs for such a control system are not acceptable, especially for small working machines. Simple working machines, like mini-excavators or the like, have mechanically operated directional control valves, which do not offer the possibility of tapping the actuating pressure for the pipe rupture protection valves. For this reason, the classical lowering brake valve is the standard solution for braking loads in interaction with mechanically operated control spools.

Depending on the respective application of a valve arrangement concerned, it is desirable, especially for small working machines, to integrate the lowering brake function into the directional control valve for cost reasons. DE 10 2005 013 823 A1 describes such a valve arrangement. However, the functionality and reliability of this valve arrangement depend on electronic sensors and an electronic control and regulating device.

A valve arrangement of the type described in the introductory part is known from DE 10 2007 020 558 A1. The prior art valve arrangement serves to supply a pressure medium to a hydraulic consumer having a directional control valve, comprising an inlet metering orifice, which specifies the volumetric flow of the pressure medium, and a directional part. The directional control valve is assigned an individual pressure compensator. The return flow from the consumer has a lowering brake valve, which is supplied in the opening direction with a pilot pressure; and connected in parallel thereto is a check valve, which opens in the direction of the consumer. In this case, the pilot pressure is tapped in a duct between the pressure compensator and the directional part. The duct is a curved duct between a pressure compensator outlet and an intermediate chamber of a supply-side and return-side directional part of the directional control valve. At the same time, a lowering brake valve can be provided in both the supply and also in the discharge; and the same pilot pressure can be applied to both. The known valve arrangement is preferably a directional control valve element of a mobile control block.

The object of the present invention is to provide a valve arrangement for actuating a load; and the actuating signal of a brake valve is uncoupled from cylinder pressures or pressures at any other load, wherein high operating reliability and enhanced switching behavior are to be guaranteed.

This object is achieved with a hydraulic valve arrangement having the features specified in claim 1 in its entirety. According to the characterizing part of claim 1, the throttle device is actuated by means of a hydraulic circuit that detects the magnitude and direction of a pressure medium flow to the load.

The invention provides a device that detects the magnitude and direction of the pressure medium flow in the valve arrangement to the load. This feature allows the dynamic pressure signal for the brake slide to be superimposed with a signal of this device for measuring the magnitude and direction of the pressure medium flow.

Such a device detects, for example, the switching position of the control spool of the directional control valve. When the control spool is switched back into a neutral position from a switching position, which corresponds to a working position of the load, then this device moves the brake slide into a switching position that corresponds to a closed position. The device or the hydraulic circuit, which detects the magnitude and direction of the pressure medium flow to the load, acts with the aid of a pressure dividing circuit in the course of moving the brake slide into a closed position in such a way that a reduced pressure, derived from the actuating pressure for the valve arrangement, actuates the brake slide.

On the other hand, when the control spool is moved into a switching position that corresponds to the opened position in the sense of a working position of the load, the dynamic pressure signal for the brake slide is superimposed with a signal of the said device in the sense that the brake slide assumes an over-proportionally fast opened position.

Furthermore, it is advantageous that such a hydraulic circuit, which can also be referred to as a brake detector with a pressure dividing circuit, is integrated into each of the two control lines for the control spool. Other advantageous embodiments of the valve arrangement according to the invention are the subject matter of the additional dependent claims.

Since the throttle device is adjusted by a dynamic pressure derived from a load signal or load sensing signal, a design feature is introduced that prevents a positive feedback of pressure increases in the load in the actuating pressure or the actuating signal for the brake valve. Preferably, the dynamic pressure derived from a load sensing signal is tapped from a metering orifice of the directional slide or control piston of a directional control valve. A pressure compensator of such a directional control valve is able to generate the dynamic pressure correlated with the load signal. The throttle device can be designed as a metering orifice, in particular as a variable metering orifice. In order to achieve an especially compact design of the valve arrangement, it may be practical to integrate a brake slide of a lowering brake valve into an existing control spool of the directional control valve.

A dynamic pressure signal represents basically a physical quantity that is available only outside brief pressure fluctuations or pressure increases in a hydraulic system. The situation is different with the pressure itself. It involves per se a filtered signal. Hence, a standard directional control valve can be expanded at a low cost into a directional control valve with a load lowering brake function. As a result, short control channels are possible; and logical switching positions of the control spool can be used to actuate the brake slide. This approach makes it easy to ensure that the throttle notches of the brake valve enable a pressure medium discharge only when the directional valve control spool is moved out of a neutral position. The throttle notches in the interior of the brake valve slide are connected in a fluid-carrying manner to the breakthroughs of the control spool in its inside passage borehole. As a result, the dynamic pressure can be applied to both face sides of the brake slide or the brake valve slide.

When a hydraulic load is in operation, the valve arrangement according to the invention reduces the pressure loss in both flow directions of a pressure medium to the load. If the load is a single-acting hydraulic cylinder, then the pressure loss decreases in the course of the lifting phase, because there is no need to flow over the check valve. In addition, the pressure loss is reduced during the lowering phase of the hydraulic cylinder, because only the pressure in an inlet chamber of the hydraulic cylinder has to be considered; and a spring force of a restoring spring for the brake slide can be reduced to about ⅕ of the value according to the current state of the art.

The hydraulic valve arrangement according to the invention is explained in detail below by means of a plurality of exemplary embodiments. In this context,

FIG. 1 is a schematic representation of an exemplary embodiment of a valve arrangement for actuating a load with a brake slide actuated by a dynamic pressure of a load sensing [LS] directional control valve;

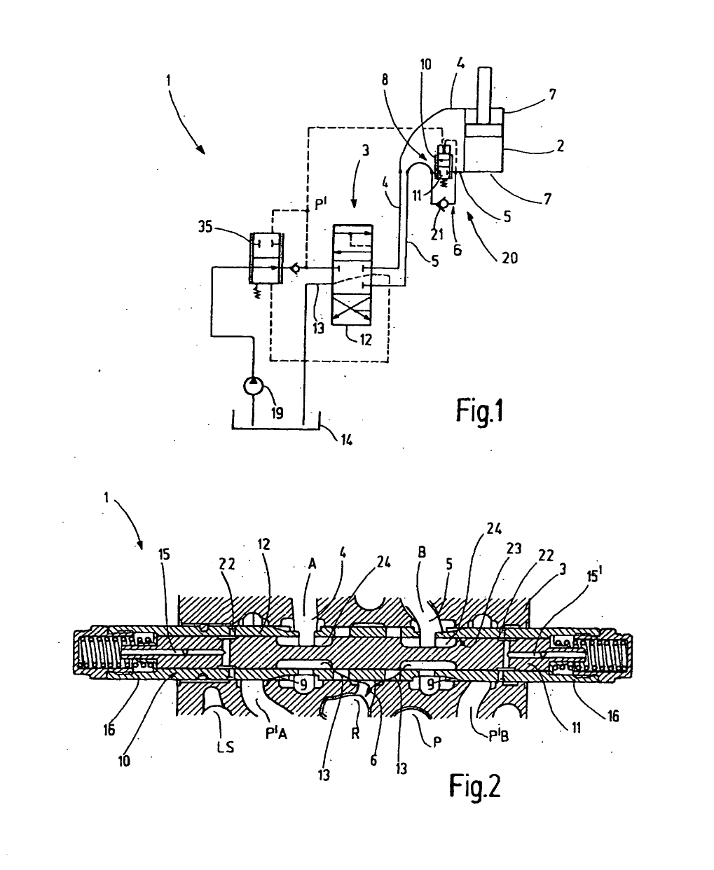

FIG. 2 is a schematic longitudinal view of an inventive valve arrangement with a brake slide integrated into a control spool of a directional control valve;

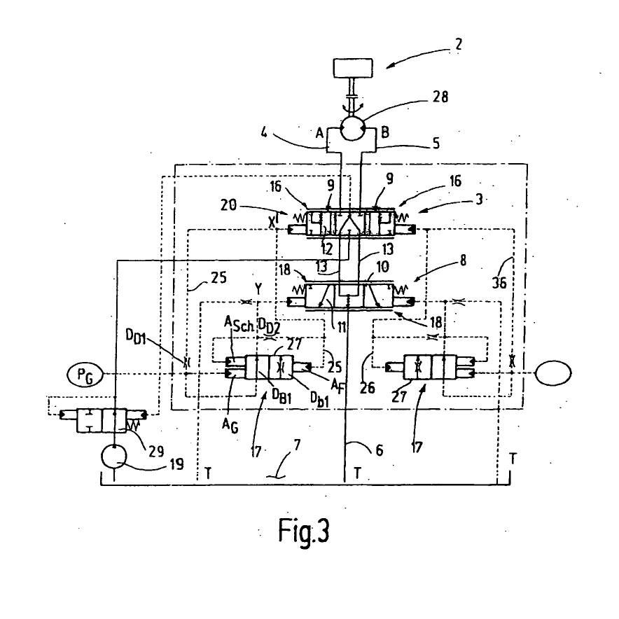

FIG. 3 is a schematic circuit diagram of an inventive valve arrangement and a hydraulic circuit, which detects the magnitude and direction of a pressure medium flow to a load;

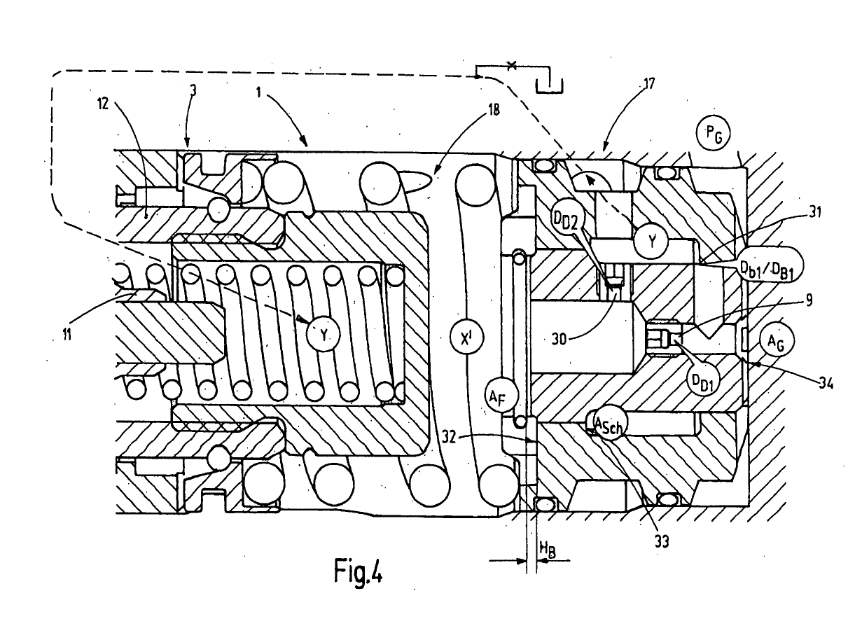

FIG. 4 is a partial schematic longitudinal view of a valve arrangement with a hydraulic circuit, which detects the magnitude and direction of a pressure medium flow to a load;

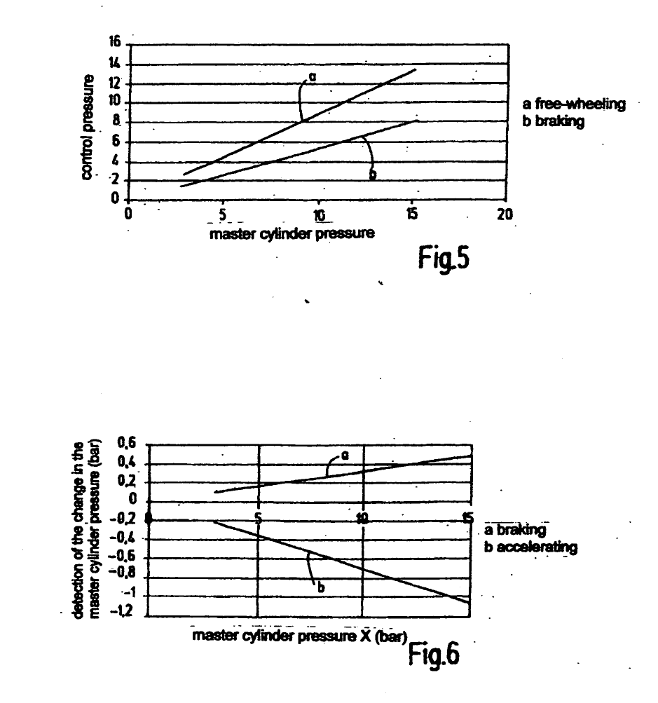

FIG. 5 shows an example of the actuating pressure profile of a brake slide of an inventive valve arrangement plotted over the actuating pressure at a control spool of a directional control valve; and

FIG. 6 shows an example of the resolution accuracy of the hydraulic circuit for detecting the magnitude and direction of the pressure medium flow to and from the load with a pressure reversal for the actuating pressure at a control spool.

FIG. 1 shows a schematic circuit diagram of an exemplary embodiment of a valve arrangement 1 for actuating a hydraulic load 2. The load 2 is designed as a double-acting hydraulic cylinder, which is driven by a pressure medium flow provided by a constant flow pump 19. The constant flow pump 19 is driven by a combustion engine (not illustrated) of a working machine, such as a mini excavator or wheel loader. The hydraulic cylinder is used, for example, to lift and lower a front working tool or an excavator grapple or bucket or the like. It goes without saying that other areas of application for the valve arrangement 1 are possible, such as in an industrial truck or in known hydraulic lifts.

The load 2 is actuated by means of an indefinitely variable directional control valve 3, of which FIGS. 1 to 3 show only exemplary embodiments. According to the drawing from FIG. 1, the directional control valve 3 is connected in a fluid conveying manner to the load 2 as a 4/3-way valve with two working lines 4, 5. If the load sensing line is also taken into consideration, it involves a 5/3-way valve. A brake valve 10 is integrated into the working line 5 that empties into a piston-side working chamber of the hydraulic cylinder. The brake valve 10 is attached directly to the hydraulic cylinder in order to be able to implement a pipe rupture protection function. In the event of a pipe rupture, a check valve 21 protects the valve arrangement 1 against a pressure medium loss. At variance with the lowering brake valve from the prior art, the lowering brake valve 20 is not opened directly by a pressure medium pressure in the respective corresponding working line 4 (rod side). Rather, a load sensing valve 35 is integrated into a pressure medium line, arranged between the constant flow pump 19 and the directional control valve 3, in order to eliminate the known instabilities of such control units according to the state of the art. A dynamic pressure p′ of this load sensing directional control valve 35 controls the function and, in so doing, the switching position of a brake slide 11 of the brake valve 10.

In this way, an instability in the control of the brake valve 10 and, thus, an uncontrolled lowering of, for example, a load are prevented. In contrast, during a lifting phase of the hydraulic cylinder or load 2, the check valve 21 is to be traversed by flow, a process that is accompanied with corresponding pressure losses. It goes without saying that other valve designs having different control logic can also be used in order to be able to implement the inventive function of the disclosed valve arrangement 1. Thus, the brake valve 10 represents a throttle device 8 that controls in a very stable way the discharge volumetric flow 6 of a pressure medium 7 in the load 2.

FIG. 2 is a schematic longitudinal view of a valve arrangement 1 comprising a directional control valve 3 with a brake slide 11 in the brake valve 10. According to the invention, this brake slide is integrated into the directional control valve and is actuated with a controlled dynamic pressure p′. The valve arrangement 1 has a pump or pressure supply port P, a return flow port R, two load ports A, B and two control ports P′_{A} and P′_{B}, and a load signal or load sensing port LS. The basic function of such a valve arrangement 1 is disclosed in several prior applications (for example, in DE 10 2007 054 137.8 A1), so that at this point there is no need to enter into the details thereof.

The valve arrangement 1 has a control spool 12, which can be displaced horizontally, when seen in the direction of FIG. 2, in the housing of the valve arrangement. This control spool is shown in its neutral position. The control spool 12 in turn serves as the housing for the brake slide 11, which can also be displaced in the horizontal direction in said housing. The control spool 12 has, besides metering orifices 9 (FIG. 4) between the control ports P′_{A} and P′_{B} and the respective load ports A and B, two breakthroughs 22 in an inner, longitudinally extending passage bore 23. These breakthroughs 22 are permanently connected to the throttle notches 24 of the brake slide 11 lying within. The throttle notches 24 can release the discharge or a fluid-carrying connection 13 to the return flow port R only if the control spool 12 is moved from the illustrated neutral position into a working position. For this purpose, one breakthrough 15, 15′ each is provided on the ends 16 of the control spool 12; and face sides 18 of the brake slide 11 can be connected to the dynamic pressure p′.

FIG. 3 shows the additional use of a hydraulic circuit 17 in a schematic circuit diagram of a valve arrangement 1 according to the invention. This hydraulic circuit enables the dynamic pressure signal for the brake slide 11 to be superimposed with a signal that maps the magnitude and direction of the pressure medium flow for the load 2. FIG. 3 also shows that such a hydraulic circuit 17, which can also be referred to as the brake detector with a pressure dividing circuit, is integrated into each of the two control lines 25, 26 for the control spool 1. When deflecting a piston 27, which is not prestressed by spring elements, the hydraulic circuit 17 passes the actuating pressure for the control spool 12 to the brake slide 11. In the course of a traversing motion of the control spool 12 in the neutral position direction, the pressure dividing circuit, which is shown in detail in FIG. 4, causes a comparatively reduced pressure to actuate the brake slide 11. The throttle device 8 or the brake valve 10 is over-proportionately closed. This feature contributes to the dynamics of, for example, the load 2, which is shown as a hydraulic motor 28 in FIG. 3, and results in a fast deceleration of the hydraulic motor 28. In addition, the circuit, according to FIG. 3, discloses a pressure compensator 29 upstream of the constant pump 19, which can serve to cut off amounts of pressure medium in order to prevent an overloading of the hydraulic motor 28.

FIG. 4 shows an embodiment of a hydraulic circuit 17 for detecting the magnitude and direction of the pressure medium flow for the respective load. This hydraulic circuit can be implemented twice, for example, on each face side of the control spool 12 in the directional control valve housing. The hydraulic circuit 17 is depicted in a longitudinally central plane of the directional control valve 3 in a longitudinal view, so that not all of the fluid-carrying connections according to the circuit diagram 3 are shown.

Referring to this circuit diagram, the depicted switching elements include in essence:
metering orifice D_{D1} for the control spool 12,
metering orifice D_{D2} between the control spool 12 (pressure X′) and the snap surface A_{Sch},
variable throttle 31 of the brake detector piston for the hydraulic circuit 17,
brake detector surface 32 (spring space of the control spool 12),
snap surface A_{Sch} or 33 at the hydraulic circuit 17, and
the master cylinder pressure contact surface 34.

FIG. 5 shows the control pressure for the brake slide 11 plotted over the actuating pressure of the control spool 12. There is linear dependence in both operating states in the working position (a) and the braking position (b) of the control spool 12. In the working position (a) of the control spool 12, there is a directly proportional relation between the aforementioned pressures, whereas in the braking position or throttling position of the brake slide 11, there is an under-proportional correlation of the pressures.

Furthermore, FIG. 6 shows the change in the actuating pressure for the brake slide 11 when braking (a) a load and when accelerating (b) a load or a consumer 2.

1. A valve arrangement for actuating a load (2), having an infinitely variable directional control valve (3), which acts as the inlet throttle and can connect a pump port (P) to the load ports (A, B); wherein the load (2) is connected to the directional control valve (3) by means of working lines (4, 5); and a discharge volumetric flow (6) of a pressure medium (7) from the load (2) can be adjusted by means of a throttle device (8) as a function of a load signal (LS) of the load (2); wherein the throttle device (8) can be adjusted by a dynamic pressure (p′) derived from the load signal (LS), characterized in that the throttle device (8) is actuated by means of a hydraulic circuit (17) that detects the magnitude and direction of a pressure medium flow (7) to the load (2).

2. The valve arrangement according to claim 1, characterized in that the throttle device (8) is a part of a brake valve (10) or a brake slide (11) of a brake valve (12); and that, when a control spool (12) of the directional control valve (3) is in a working position, the circuit (17) superimposes the dynamic pressure at a face side (18) of the brake slide (11) with an actuating pressure of the control spool (12).

3. The valve arrangement according to claim 2, characterized in that in the event of a traversing motion of the control spool (12) from a working position into a neutral position, the circuit (17) passes in an under-proportional manner the actuating pressure of the control spool (12) to the brake slide (11) and vice versa.

4. The valve arrangement according to claim 2, characterized in that a hydraulic circuit (17) is integrated into each of the two control lines (25, 26) for the control spool (1).

5. The valve arrangement according to claim 1, characterized in that the dynamic pressure (p′) serves as the determinate for the volumetric flow by way of a metering orifice (9) of the directional control valve (3).

6. The valve arrangement according to claim 1, characterized in that the dynamic pressure (p′) is tapped from a pressure compensator (29) of the directional control valve (3).

7. The valve arrangement according to claim 2, characterized in that the brake slide (11) is built into the control spool (12) of the directional control valve (3) and can be axially displaced relative to said directional control valve.

8. The valve arrangement according to claim 2, characterized in that the brake slide (11) releases a fluid-carrying connection (13) from the load (2) to a pressure medium tank (14), when the control spool (12) is in a switching position that corresponds to a working position for the load (2).

9. The valve arrangement according to claim 2, characterized in that the brake slide (11) can be supplied via breakthroughs (15, 15′) with the dynamic pressure (p′) at the ends of the control spool (12) on its two face sides.
